(19) United States
(12) Patent Application Publication
(10) Pub. No.: US 2010/0085107 A1
(43) Pub. Date: Apr. 8, 2010

(54) Trim fuse circuit capable of disposing trim conducting pads on scribe lines of wafer

(76) Inventors: Chao-Hsing Huang, Hsinchu City (TW); Chun-Liang Yeh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/277,313

(22) Filed: Nov. 25, 2008

(30) Foreign Application Priority Data
Oct. 3, 2008 (TW) 097138087

(51) Int. Cl. H01H 85/00

(52) U.S. Cl. 327/525

(57) ABSTRACT

A trim fuse circuit includes a metal fuse, a trim pad coupled to the first end of the metal fuse, a first transistor coupled to the first end of the metal fuse, a second transistor coupled to the second end of the metal fuse, an inverter coupled to the second end of the metal fuse, a switch coupled to the second end of the metal fuse, and a common trim pad coupled to the control end of the switch. The inverter outputs a data signal according to the status of the metal fuse. The trim pad can be disposed on the scribe line of a wafer. When the trim pad is cut and accordingly connects to the substrate of the wafer, the data signal is not affected.

### BACKGROUND OF THE INVENTION

1. Field of the Invention

The present invention relates to a trim fuse circuit, and more particularly, to a trim fuse circuit capable of disposing trim conducting pads on scribe lines of a wafer.

2. Description of the Prior Art

Please refer to FIG. 1. FIG. 1 is a diagram illustrating a voltage reference circuit 100. The voltage reference circuit 100 is utilized to generate a reference voltage V_{REF} with a magnitude decided by the reference circuit 100. As shown in FIG. 1, the voltage reference circuit 100 comprises a constant current source I_{REF}, five resistors R₁, R₂, R₃, R₄, and R₅, and four switches SW₁, SW₂, SW₃ and SW₄. The current generated by the constant current source I_{REF} is set as 1 micro-Amp and the five resistors R₁˜R₅ are all set as 1 mega-ohm. The switches SW₁˜SW₄ respectively short out the corresponding resistors according to the switch control signals S₁˜S₄. If the switch control signal is logic “0” (low voltage level), the switch is turned off. On the contrary, if the switch control signal is logic “1” (high voltage level), the switch is turned on and the corresponding resistor is short-circuited. For example, when switch control signal S₁ is logic “0”, the switch SW₁ is turned off so that the current from the constant current source I_{REF} passes through the resistor R₁ and a voltage drop over the resistor R₁ is generated. When switch control signal S₁ is logic “1”, the switch SW₁ is turned on so that the current from the constant current source I_{REF} passes through the switch SW₁ and no voltage drop is generated. As shown in FIG. 1, when the switch control signals S₁˜S₄ are set as [1111], the switches SW₁˜SW₄ are turned on so that the generated reference voltage V_{REF} is 1 volt (V_{REF}=I_{REF}×R₅=1×1=1). When the switch control signals S₁˜S₄ are set as [1110], the switches SW₁˜SW₃ are turned on and the switch SW₄ is turned off. Consequently, the generated reference voltage V_{REF} is 2 volts (V_{REF}=I_{REF}×(R₄+R₅)=1×2=2) and so on. Therefore, the reference voltage V_{REF} can be adjusted as required according to the switch control signals S₁˜S₄.

Please refer to FIG. 2. FIG. 2 is a diagram illustrating a conventional trim fuse circuit 200. The trim fuse circuit 200 is utilized for generating the switch control signals S₁˜S₄. The user can set the status of the trim circuit 200 in order to set the logic (voltage level) of the switch control signals S₁˜S₄. The trim fuse circuit 200 comprises four fuse sets 211, 212, 213 and 214, a trim control module 220 and a current control module 230.

The current control module 230 comprises a transistor Q₁ and a constant current source I_{REF}. The current control module 230 is utilized to form current mirrors with the transistors Q₁₁, Q₂₁, Q₃₁ and Q₄₁ in the fuse sets 211, 212, 213 and 214 for duplicating currents with the same magnitude as the current from the constant current source I_{REF}. A first end (source) of the transistor Q₁ is electrically connected to a voltage source V_{DD} (for example, 5 volt). A second end (drain) of the transistor Q₁ is electrically connected to the constant current source I_{REF}. A control end (gate) of the transistor Q₁ is electrically connected to the second end of the transistor Q₁ and the control ends of the transistors Q₁₁, Q₂₁, Q₃₁, and Q₄₁. The constant current source I_{REF} is electrically connected between the second end of the transistor Q₁ and a voltage source V_{SS} (for example, a ground end, 0 volt). The transistor Q₁ can be a P channel Metal Oxide Semiconductor (PMOS) transistor.

The fuse sets 211˜214 are respectively utilized to provide the logic (voltage level) of the switch control signals S₁˜S₄. That is, after the trim control module 220 trims, the fuse sets 211˜214 generate the switch control signals S₁˜S₄ with the fixed logic. The fuse sets 211˜214 have the same structure, so only the fuse set 211 is illustrated and the description of the rest fuse sets is similar and will not be repeated again. The fuse set 211 comprises two transistors Q₁₁ and Q₁₂, a fuse PF₁ and an inverter INV₁. A first end (source) of the transistor Q₁₁ is electrically connected to the voltage source V_{DD}. A second end (drain) of the transistor Q₁₁ is electrically connected to a second end (drain) of the transistor Q₁₂. A control end (gate) of the transistor Q₁₁ is electrically connected to the control end of the transistor Q₁. In this way, the transistor Q₁₁ can form a current mirror with the transistor Q₁ for duplicating the current from the constant current source I_{REF}. A first end (source)(the node N₁) of the transistor Q₁₂ is electrically connected to the resistor R_{COM} and the common trim conducting pad of the trim control module 220 through the fuse PF₁. A second end (drain) of the transistor Q₁₂ is electrically connected to a second end of the transistor Q₁₁. A control end (gate) of the transistor Q₁₂ is electrically connected to the second end of the transistor Q₁₂. Thus, the transistor Q₁₂ is utilized as a diode. The input end of the inverter INV₁ is electrically connected to the node N₁. The output end of the inverter INV₁ outputs the switch control signal S₁ according to the voltage level on the input end of the invert INV₁ (the voltage level on the node N₁). The inverter INV₁ can be designed that when the voltage level on the input end of the inverter INV₁ is higher than 2 volts (the voltage level on the node N₁ higher than 2 volts), the output (switch control signal S₁) of the inverter INV₁ is logic “0”, and when the voltage level on the input end of the inverter INV₁ is lower than 0.5 volt (the voltage level on the node N₁ lower than 0.5 volt), the output (switch control signal S₁) of the inverter INV₁ is logic “1”.

In addition, the transistor Q₁₁ can be a PMOS transistor and the transistor Q₁₂ can be an N channel Metal Oxide Semiconductor (NMOS) transistor. The fuse PF₁ can be a poly-silicon fuse with an impedance about 99 ohms.

The trim control module 220 comprises four trim conducting pads P_{T1}, P_{T2}, P_{T3} and P_{T4}, a common trim conducting pad P_{COM} and a resistor R_{COM}. The trim conducting pads P_{T1}, P_{T2}, P_{T3} and P_{T4} are respectively electrically connected to the nodes N₁, N₂, N₃ and N₄. The common trim conducting pad P_{COM} is electrically connected to all the fuses PF₁˜PF₄. The resistor R_{COM} is electrically connected between all the fuses PF₁˜PF₄ and the voltage source V_{SS} and is utilized as a pull-low resistor. The impedances of the fuses PF₁˜PF₄ limit the currents passing through the fuses PF₁˜PF₄ during the prediction phase to prevent the fuses PF₁˜PF₄ from being burned out.

During the prediction phase, the trim conducting pads P_{T1}˜P_{T4} are utilized to receive the trim prediction voltages (for example, 2 volts or 0 volt) and transmit the received trim prediction voltages to the corresponding inverters for predicting if the generated logic of the switch control signals are as required. During the trim phase, the trim conducting pads P_{T1}˜P_{T4} are utilized to receive the trim set voltage (for example, 5 volt) and the common trim conducting pad P_{COM} is utilized to receive the trim common voltage (for example, 0 volt) for trimming the fuses as desired.

For example, during the prediction phase, the trim conducting pad P_{T1} receives a voltage with 2 volts and transmits to the node N₁ (the input end of the inverter INV₁). As a result, the switch control signal S₁ outputted from the inverter INV₁ during the prediction phase is logic “0”. On the contrary, during the prediction phase, the trim conducting pad P_{T1} receives a voltage with 0 volt and transmits to the node N₁ (the input end of the inverter INV₁). As a result, the switch control signal S₁ outputted from the inverter INV₁ during the prediction phase is logic “1”.

After the prediction phase, if the switch control signal is determined to be logic “0”, during the trim phase, the trim conducting pad P_{T1} receives a trim set voltage with 5 volts and the common trim conducting pad P_{COM} receives a trim common voltage with 0 volt. Consequently, the voltage drop across the fuse PF₁ is 5 volts so that a large current passes through and burns out the fuse PF₁ and the connection established by the fuse PF₁ is broken (open-circuited). In such condition, the node N₁ is not electrically connected to the voltage source V_{SS} through the fuse PF₁ and the resistor R_{COM} and does not keep at a low level. Instead, the node N₁ is electrically connected to the voltage source V_{DD} through the transistors Q₁₁ and Q₁₂ so as to keep at a high voltage level (higher than 2 volts). Thus, the inverter INV₁ outputs the switch control signal S₁ with the logic “0”.

On the contrary, after the prediction phase, if the switch control signal is determined to be logic “1”, during the trim phase, the trim conducting pad P_{T1} does not receive the trim set voltage with 5 volts. That is, the voltage on the trim conducting pad PF₁ is floating. The common trim conducting pad P_{COM} still receives the trim common voltage with 0 volt. Consequently, there is no voltage drop across the fuse PF₁ so that no large current passes through the fuse PF₁ and the fuse PF₁ is not burned out. In such condition, the node N₁ is electrically connected to the voltage source V_{SS} through the fuse PF₁ and the resistor R_{COM} so as to keep at a low voltage level (lower than 0.5 volt). Thus, the inverter INV₁ outputs the switch control signal S₁ with the logic “1”.

Please refer to FIG. 3. FIG. 3 is a diagram illustrating the conventional trim fuse circuit 200 during the prediction phase. During the prediction phase, different trim prediction voltages (for example, 0 volt or 2 volt) can be set on the trim conducting pads P_{T1}˜P_{T4} so that the inverters INV₁˜INV₄ generate the corresponding switch control signals S₁˜S₄ accordingly. In such condition, the reference voltage V_{REF} is obtained from the reference voltage circuit 100 controlled by the switch control signals S₁˜S₄ which are determined in the prediction phase. If the obtained reference voltage V_{REF} is as desired, then the trim fuse circuit 200 enters the trim phase to trim the fuses to be trimmed; if not, different trim prediction voltages are set on the trim conducting pads P_{T1}˜P_{T4} over and over again so that the inverters INV₁˜INV₄ generate the corresponding switch control signals S₁˜S₄ accordingly until the obtained reference voltage V_{REF} is as desired. As shown in FIG. 3, the trim conducting pads P_{T1}, P_{T2}, P_{T3} and P_{T4} respectively receive the trim prediction voltages with 2, 0, 2, and 0 volts. As a result, the switch control signals S₁˜S₄ generated from INV₁, INV₂, INV₃, and INV₄ are [0101]. According to the logic of the switch control signals S₁˜S₄ ([0101]), the voltage reference circuit 100 generates the reference voltage V_{REF} with 3 volts (V_{REF}=1×(R₁+R₃+R₅)=1×(1+1+1)=3). If the required voltage level of the reference voltage is 3 volts, then the trim fuse circuit 200 enters the trim phase for trimming the fuses required to be burned out.

Please refer to FIG. 4. FIG. 4 is a diagram illustrating the conventional trim fuse circuit 200 during the trim phase. According to the FIG. 3, it is known that the switch control signals S₁˜S₄ are [0101] eventually. That is, the fuses PF₁ and PF₃ are required to be trimmed (burned out) so that the connections established by the fuses PF₁ and PF₃ are broken (open-circuited). In this way, the nodes N₁ and N₃ keep at the high voltage level respectively by being electrically connected to the voltage source V_{DD} through the transistors Q₁₂ and Q₃₂. Therefore, the inverters INV₁ and INV₃ output the switch control signals S₁ and S₃ with logic “0”. The fuses PF₂ and PF₄ are not required to be trimmed (burned out). Thus, the nodes N₂ and N₄ still keep at the low voltage respectively by being electrically connected to the voltage source V_{SS} through the fuses PF₂, PF₄ and the resistor R_{COM} so that the inverters INV₂ and INV₄ output the switch control signals S₂ and S₄ with logic “1”. Consequently, during the trim phase, for burning out the fuses PF₁ and PF₃, the received voltages on trim conducting pads P_{T1} and P_{T3} are required to be 5 volts and the received voltage on the common conducting pad P_{COM} are required to be 0 volt so that the large currents pass through and burn out the fuses PF₁ and PF₃.

However, the trim conducting pads P_{T1}˜P_{T4} are required to use probe-contacting for receiving the trim prediction voltages or the trim set voltages. As a result, the areas of the trim conducting pads P_{T1}˜P_{T4} must be large enough. In such condition, if the trim conducting pads P_{T1}˜P_{T4} are disposed in the chips on the wafer, the available area in the chips decreases extremely. Consequently, by means of the conventional technology, the trim conducting pads P_{T1}˜P_{T4} are disposed on the scribe lines of the wafer for increasing the available area in the chips.

Please refer to FIG. 5. FIG. 5 is a diagram illustrating the trim conducting pads being disposed on the scribe line when a wafer is being scribed. As shown in FIG. 5, because the trim conducting pads P_{T1}˜P_{T4} are disposed on the scribe line of the wafer, when the wafer is scribed to generate chips, the trim conducting pads P_{T1}˜P_{T4} are scribed as well. In general, all of the trim conducting pads are made in metal. Since the metal has good malleability, the trim conducting pads P_{T1}˜P_{T4} may be stretched because of being scribed, and therefore contact the substrate of the wafer. Generally speaking, the substrate of the P-type substrate wafer is utilized to be the common voltage source V_{SS} (ground end, 0 volt) and the substrate of the N-type substrate wafer is utilized to be the common voltage source V_{DD} (for example, 5 volts). Thus, after being scribed, the trim conducting pads P_{T1}˜P_{T4} are possible to receive the voltage provided by the voltage sources V_{DD} or V_{SS} and the switch control signals are affected so that the actual reference voltage is different from expected.

Please refer to FIG. 6. FIG. 6 is a diagram illustrating that the trim conducting pad contacts the substrate of the wafer, causing the incorrect switch control signals. The fuse set 212 is illustrated in FIG. 6. The rest fuse sets can be derived and not to be repeated again. Suppose that the substrate of the wafer shown in FIG. 6 is the N-type substrate. After the prediction phase shown in FIG. 3 and the trim phase shown in FIG. 4, the fuse PF₂ of the fuse set 212 is determined not to be trimmed (burned out) so that the voltage on the node N₂ is pulled to be at the low voltage level by being electrically connected to the voltage source V_{SS} through the resistor R_{COM}. Hence, the switch control signal S₂ outputted from the inverter INV₂ is logic “1”. However, after being scribed, the trim conducting pad P_{T2} is stretched to be electrically connected to the N-type substrate. Therefore, the trim conducting pad P_{T2} receives the voltage provided by the voltage source V_{DD} (for example, 5 volts) and transmits the received voltage to the node N₂. In this way, the voltage on the node N₂ is raised up to the high voltage level due to the voltage source V_{DD}. It means that the switch control signal S₂ outputted from the inverter INV₂ becomes logic “0” and not to be the required logic “1”. In such condition, the obtained reference voltage is not as the same as expected, which causes inconvenience.

### SUMMARY OF THE INVENTION

The present invention provides a trim fuse circuit capable of disposing trim conducting pads on a scribe line of a wafer. The trim fuse circuit comprises a current control module, a fuse set, and a trim control module. The current control module comprises a transistor and a constant current source. The transistor comprises a first end electrically connected to a first voltage source, a second end and a control end. The constant current source is electrically connected to the second end of the transistor of the current control module for generating a reference current. The fuse set comprises a first transistor, a second transistor, a fuse, and an inverter. The first transistor comprises a first end electrically connected to a second voltage source, a second end and a control end electrically connected to the second end of the first transistor of the fuse set. The second transistor comprises a first end electrically connected to the first voltage source, a second end and a control end electrically connected to the control end of the transistor of the current control module. The second transistor of the fuse set and the transistor of the current control module form a current mirror for generating the reference current from the second end of the second transistor of the fuse set. The fuse comprises a first end electrically connected to the second end of the first transistor of the fuse set, and a second end electrically connected to the second end of the second transistor of the fuse set. The inverter comprises an input end electrically connected to the second end of the fuse and an output end for generating an information signal. When voltage level on the input end of the inverter is higher than a first predetermined voltage level, the information signal is at a low voltage level. When voltage level on the input end of the inverter is lower than a second predetermined voltage level, the information signal is at a high voltage level. The trim control module comprises a trim conducting pad, a common trim conducting pad, and a switch. The trim conducting pad is disposed on the scribe line of the wafer. The switch comprises a first end electrically connected to the input end of the inverter of the fuse set, a second end electrically connected to the first voltage source, and a control end electrically connected to the common trim conducting pad. The first end of the switch is electrically connected to the second end of the switch according to voltage on the common trim conducting pad.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a voltage reference circuit.

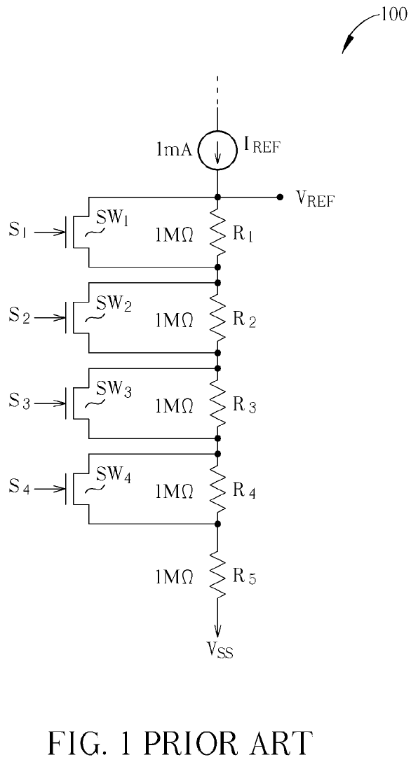

FIG. 2 is a diagram illustrating a conventional trim fuse circuit.

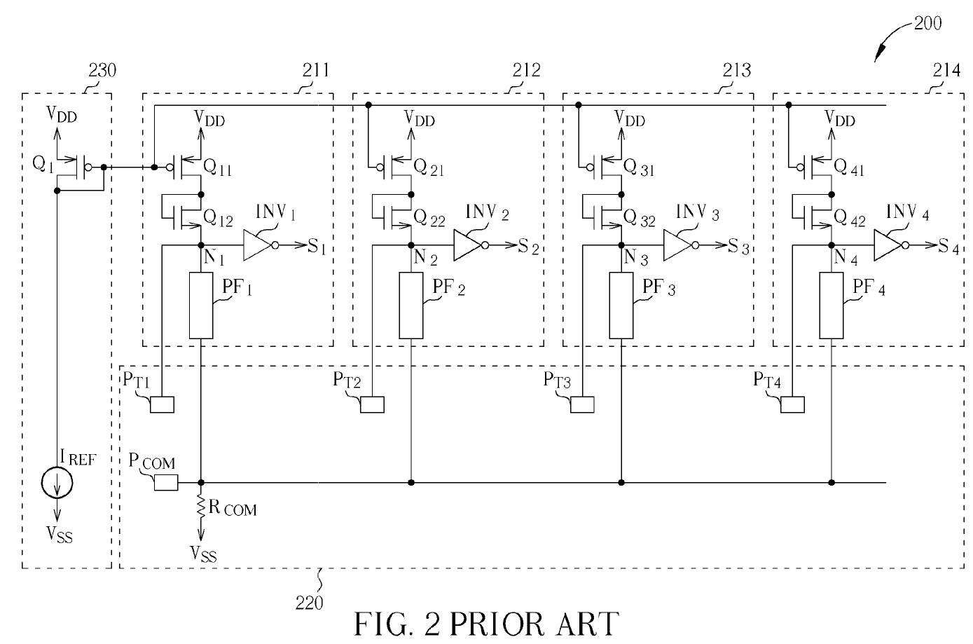

FIG. 3 is a diagram illustrating the conventional trim fuse circuit during the prediction phase.

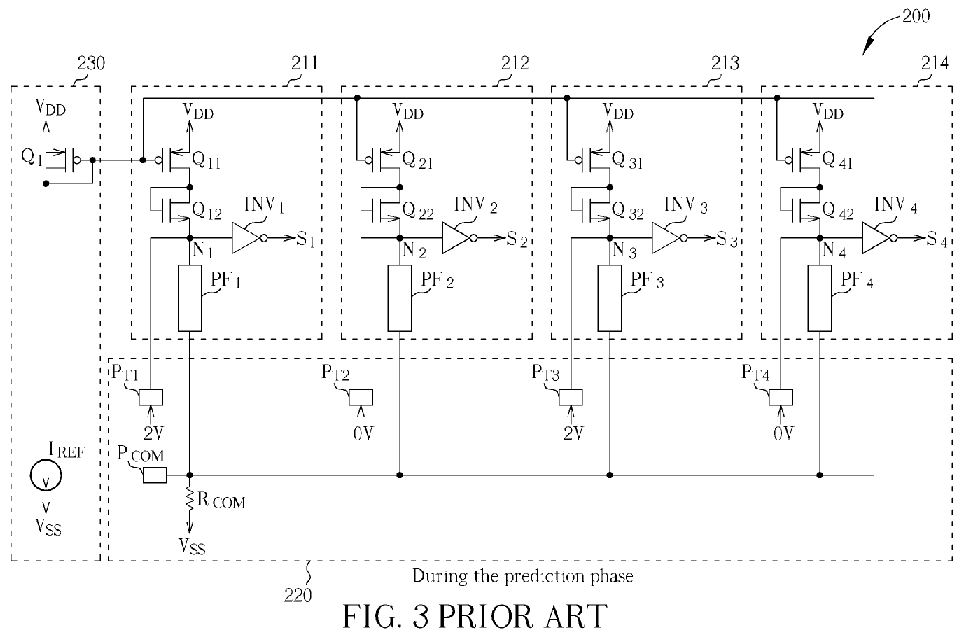

FIG. 4 is a diagram illustrating the conventional trim fuse circuit during the trim phase.

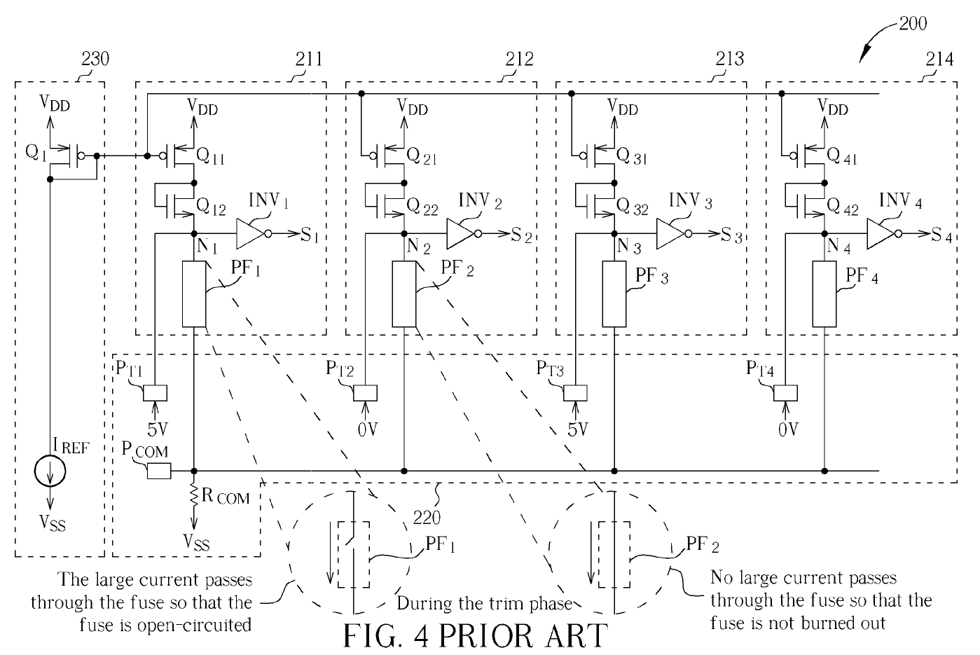

FIG. 5 is a diagram illustrating the trim conducting pads being disposed on the scribe line.

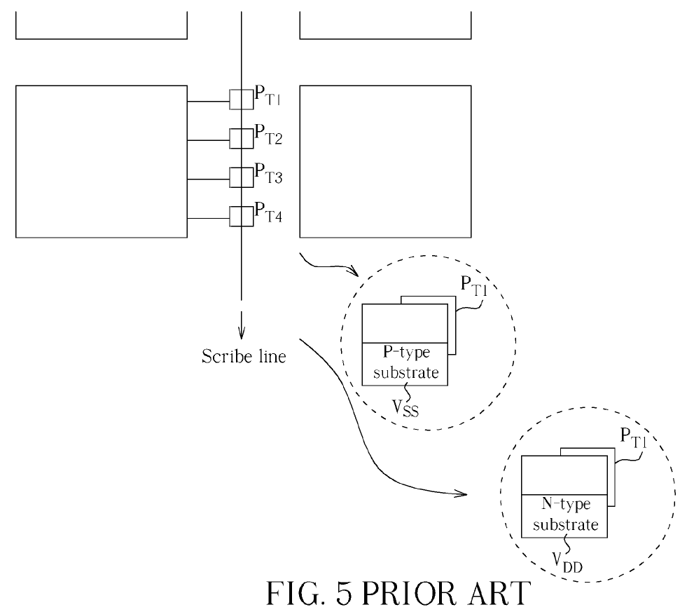

FIG. 6 is a diagram illustrating that the trim conducting pad contacts the substrate of the wafer.

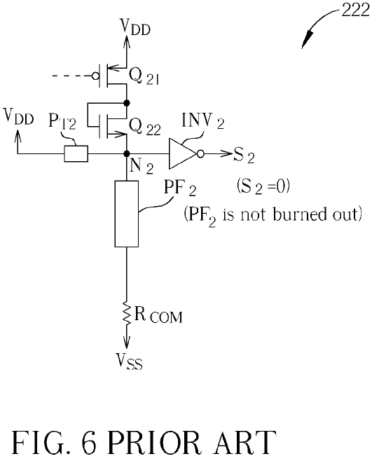

FIG. 7 is a diagram illustrating a trim fuse circuit according to a first embodiment of the present invention.

FIG. 8 is a diagram illustrating a trim fuse circuit during the prediction phase of the first embodiment of the present invention.

FIG. 9 is a diagram illustrating a trim fuse circuit during the trim phase of the first embodiment of the present invention.

FIG. 10 is a diagram illustrating that there is still no incorrect switch control signal generated in the first embodiment of the present invention.

FIG. 11 is a diagram illustrating a trim fuse circuit of a second embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “electrically connect” is intended to mean either an indirect or direct electrical connection. Accordingly, if one device is electrically connected to another device, that connection may be through a direct electrical connection, or through an indirect electrical connection via other devices and connections.

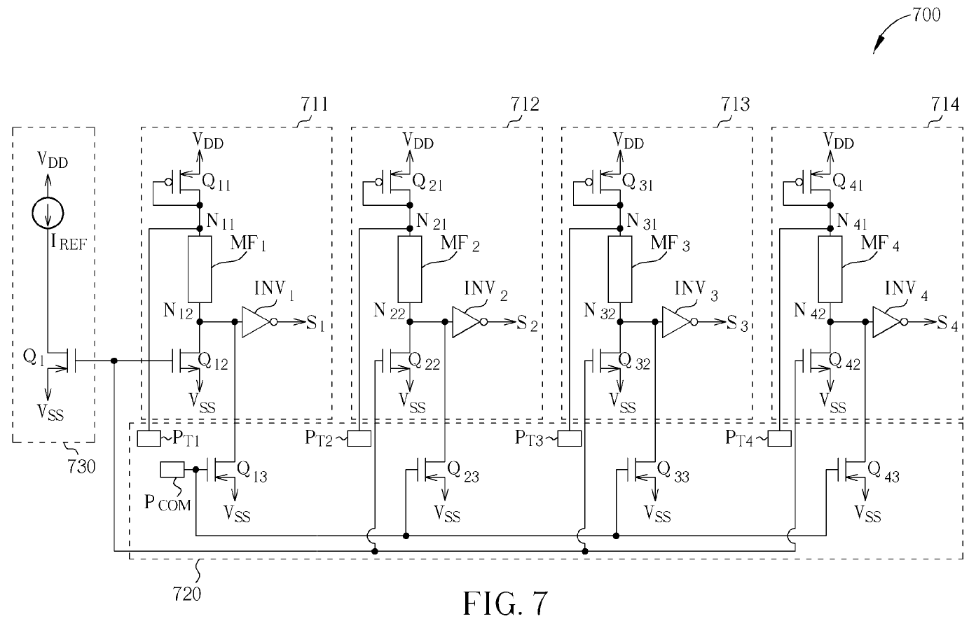

Please refer to FIG. 7. FIG. 7 is a diagram illustrating a trim fuse circuit 700 according to a first embodiment of the present invention. The trim fuse circuit 700 is utilized for generating the switch control signals S₁˜S₄. The trim fuse circuit 700 is utilized in the fabrication of the N-type substrate wafer. The trim fuse circuit 700 can be set by users for controlling the logic (voltage level) of the switch control signals S₁˜S₄. However, the switch control signals S₁˜S₄ of the trim fuse circuit 700 are not limited to be utilized in the reference circuit 100. That is, the switch control signals can be treated as various information signals according to the design. The trim fuse circuit 700 comprises four fuse sets 711, 712, 713, 714, a trim control module 720, and a current control module 730.

The current control module 730 comprises a transistor Q₁ and a constant current source I_{REF}. The constant current source I_{REF} is utilized to form the current mirrors with the transistors Q₁₂, Q₂₂, Q₃₂ and Q₄₂ for duplicating the currents with the same magnitude as the current of the constant current source I_{REF}. A first end (source) of the transistor Q₁ is electrically connected to a voltage source V_{SS} (for example, a ground end, 0 volt). A second end (drain) of the transistor Q₁ is electrically connected to the constant current source I_{REF}. A control end (gate) of the transistor Q₁ is electrically connected to the second end of the transistor Q₁ and the control ends of the transistors Q₁₂, Q₂₂, Q₃₂, and Q₄₂. The constant current source I_{REF} is electrically connected to the second end of the transistor Q₁ and a voltage source V_{DD} (for example, 5 volts). In the first embodiment of the present invention, the transistor Q₁ is an N channel Metal Oxide Semiconductor (NMOS) transistor.

The fuse sets 711˜714 are respectively utilized for providing the logic (voltage level) of the switch control signals S₁˜S₄. It means that after the trim phase of the trim control module 720, the fuse sets 711˜714 generate the switch control signals S₁˜S₄ with the fixed logic. The fuse sets 711˜714 have the same structures. The fuse set 711 is illustrated in the following description and the rest fuse sets can be derived and will not be repeated again. The fuse set 711 comprises two transistors Q₁₁ and Q₁₂, a fuse MF₁ and an inverter INV₁. A first end (source) of the transistor Q₁₂ is electrically connected to the voltage source V_{SS}. A second end (drain) (the node N₁₂) is electrically connected to a second end (drain) (the node N₁₁) of the transistor Q₁₁ through the fuse MF₁. A control end (gate) of the transistor Q₁₂ is electrically connected to the control end of the transistor Q₁. In such condition, the transistor Q₁₂ forms a current mirror with the transistor Q₁ for duplicating the current of the constant current source I_{REF}. A first end (source) of the transistor Q₁₁ is electrically connected to the voltage source V_{DD}. A second end (drain) of the transistor Q₁₁ is electrically connected to the second end of the transistor Q₁₂ through the fuse MF₁. A control end (gate) of the transistor Q₁₁ is electrically connected to the second end of the transistor Q₁₁. In this way, the transistor Q₁₁ is utilized as a diode (the gate and the source of the transistor Q₁₁ are electrically connected). The input end of the inverter INV₁ is electrically connected to the node N₁₂. The output end of the inverter INV₁ outputs the switch control signals S₁ according to the voltage on the input end of the inverter INV₁ (the voltage on the node N₁₂). The inverter INV₁ can be designed that when the voltage on the input end of the inverter INV₁ is higher than 2 volts (the voltage on the node N₁₂ is higher than 2 volts), the output of the inverter INV₁ (the switch control signal S₁) is logic “0”, and when the voltage on the input end of the inverter INV₁ is lower than 0.5 volt (the voltage on the node N₁₂ is lower than 0.5 volt), the output of the inverter INV₁ (the switch control signal S₁) is logic “1”.

Furthermore, in the fuse sets 711˜714 of the first embodiment of the present invention, the transistors Q₁₁, Q₂₁, Q₃₁ and Q₄₁ are PMOS transistors, and the transistors Q₁₂, Q₂₂, Q₃₂ and Q₄₂ are NMOS transistors. The fuses MF₁, MF₂, MF₃ and MF₄ are metal fuses with the impedance about 0.1 ohm.

The trim control module 720 comprises four trim conducting pads P_{T1}, P_{T2}, P_{T3} and P_{T4}, a common trim conducting pad P_{COM} and four transistors Q₁₃, Q₂₃, Q₃₃ and Q₄₃. The transistors Q₁₃, Q₂₃, Q₃₃ and Q₄₃ corresponds to the fuse sets 711˜714, respectively. The trim conducting pads P_{T1}, P_{T2}, P_{T3} and P_{T4} are respectively electrically connected to the nodes N₁₁ (a first end of the fuse MF₁), N₂₁ (a first end of the fuse MF₂), N₃₁ (a first end of the fuse MF₃) and N₄₁ (a first end of the fuse MF₄). The common trim conducting pad P_{COM} is electrically connected to the control ends (gates) of the transistors Q₁₃˜Q₄₃ for receiving a trim common voltage (for example, 5 volt) during the trim phase in order to turn on the transistors Q₁₃˜Q₁₄ so as to trim the fuses required to be burned out. The transistors Q₁₃˜Q₄₃ are connected to the corresponding fuses with the same manner, and therefore only the transistor Q₁₃ is illustrated as an example and the related description for the rest transistors will not be repeated again. A first end (source) of the transistor Q₁₃ is electrically connected to the voltage source V_{SS} (ground end, 0 volt). A second end (drain) of the transistor Q₁₃ is electrically connected to the node N₁₂ (the input end of the inverter INV₁) (a second end of the fuse MF₁). A control end (gate) of the transistor Q₁₃ is electrically connected to the common trim conducting pad P_{COM}.

In addition, in the trim control module 720 of the first embodiment of the present invention, the transistors Q₁₃˜Q₄₃ are NMOS transistors. The transistors Q₁₃˜Q₄₃ are treated as the switches for electrically connecting the nodes N₁₂˜N₄₂ to the voltage source V_{SS} respectively.

During the prediction phase, the trim conducting pads P_{T1}˜P_{T4} are utilized to receive the trim prediction voltages (for example, 0 or 2 volts) and transmit to the corresponding inverters through the corresponding fuses for determining if the logic of the generated switch control signals are as required. During the trim phase, the trim conducting pads P_{T1}˜P_{T4} are utilized to receive the trim set voltages (for example, 5 volts) and the trim common conducting pads P_{COM} is utilized to receive the trim common voltage (for example, 5 volts) for burning out the fuses as desired.

For example, during the prediction phase, the trim conducting pad P_{T1} receives the trim prediction voltage with 2 volts and transmits the trim prediction voltage to the node N₁₂ (the input end of the inverter INV₁) through the node N₁₁ and the fuse MF₁. As a result, during the prediction phase, the switch control signal S₁ outputted from the inverter INV₁ is logic “0”. On the contrary, during the prediction phase, the trim conducting pad P_{T1} receives the trim prediction voltage with 0 volt and transmits the trim prediction voltage to the node N₁₂ (the input end of the inverter INV₁) through the node N₁₁ and the fuse MF₁. As a result, during the prediction phase, the switch control signal S₁ outputted from the inverter INV₁ is logic “1”.

After the prediction phase, if the user determines that the switch control signal S₁ is required to be the logic “0”, the trim conducting pad P_{T1} does not receive the trim set voltage with 5 volts during the trim phase. That is, the voltage on the trim conducting pad P_{T1} is floating and the common trim conducting pad P_{COM} receives the trim common voltage with 5 volts. Meanwhile, the transistor Q₁₃ is turned on by the trim common voltage with 5 volts on the common trim conducting pad P_{COM} so that the second end of the fuse MF₁ is electrically connected to the voltage source V_{SS}. Therefore, there is no voltage drop with 5 volts across the fuse MF₁ so that no large current passes through the fuse MF₁ and the fuse MF₁ is not burned out. Since the current I_{REF} is a current with relatively small magnitude, the node N₁₂ is electrically connected to the voltage source V_{DD} through the fuse MF₁ and the transistor Q₁₁ and therefore the voltage on the node N₁₂ is kept at a high voltage level (higher than 2 volts). Consequently, the switch control signal S₁ outputted from the inverter INV₁ is logic “0”.

On the contrary, after the prediction phase, if the user determines that the switch control signal S₁ is required to be the logic “1”, the trim conducting pad P_{T1} receives the trim set voltage with 5 volts and the common trim conducting pad P_{COM} receives the trim common voltage with 5 volts during the trim phase. Meanwhile, the transistor Q₁₃ is turned on by the trim common voltage with 5 volts on the common trim conducting pad P_{COM} so that the second end of the fuse MF₁ is electrically connected to the voltage source V_{SS}. Thus, the voltage on the first end of the fuse MF₁ (the node N₁₁) is 5 volts and the voltage on the second end of the fuse MF₁ (the node N₁₂) is 0 volt. That is, the voltage drop across the fuse MF₁ is 5 volts and the fuse MF₁ is burned out because of the large current passing through. In this way, the node N₁₂ is not able to electrically connect to the voltage source V_{DD} through the fuse MF₁ and the transistor Q₁₁. Instead, the node N₁₂ is electrically connected to the voltage source V_{SS} through the transistor Q₁₂ so as to keep the voltage on the node N₁₂ at a low voltage level (lower than 0.5 volt). Consequently, the switch control signal S₁ outputted from the inverter INV₁ is logic “1”.

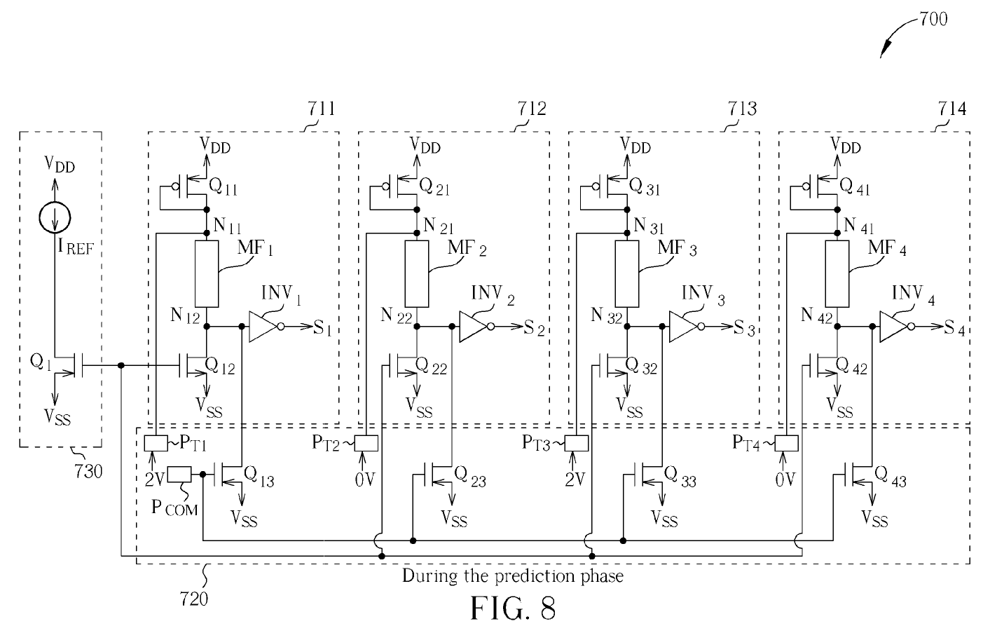

Please refer to FIG. 8. FIG. 8 is a diagram illustrating a trim fuse circuit 700 during the prediction phase of the first embodiment of the present invention. During the prediction phase, different trim prediction voltages (for example, 0 or 2 volts) are respectively given on the trim conducting pads P_{T1}˜P_{T4} and are respectively transmitted to the inverters INV₁˜INV₄ through the nodes N₁₁˜N₄₁, the fuses MF₁˜MF₄, and the nodes N₁₂˜N₄₂ so that the inverters INV₁˜INV₄ generate the switch control signals S₁˜S₄ with the corresponding logic. For example, the trim conducting pad P_{T1} receives the trim prediction voltage with 2 volts and transmits the trim prediction voltage to the node N₁₂ (the input end of the inverter INV₁) through the node N₁₁ and the fuse MF₁ so that the inverter INV₁ outputs the switch control signal S₁ with the logic “0”. In this way, the reference voltage V_{REF} is obtained from the reference voltage circuit 100 according to the switch control signals S₁˜S₄. If the obtained reference voltage V_{REF} is as desired, then the trim fuse circuit 700 enters the trim phase to trim the fuses required to be burned out; if not, different trim prediction voltages are given on the trim conducting pads P_{T1}˜P_{T4} over and over again for the inverters INV₁˜INV₄ generating the corresponding switch control signals S₁˜S₄ accordingly until the obtained reference voltage V_{REF} is as desired, and then the trim fuse circuit 700 is allowed to enter the trim phase to trim the fuses required to be burned out. As shown in FIG. 8, the trim conducting pads P_{T1}, P_{T2}, P_{T3} and P_{T4} respectively receive 2, 0, 2 and 0 volt. As a result, the switch control signals S₁˜S₄ outputted from the inverters INV₁, INV₂, INV₃ and INV₄ are [0101]. According to the logic of the switch control signals S₁˜S₄ ([0101]), the reference circuit 100 generates the reference voltage V_{REF} with 3 volts (V_{REF}=1×(R₁+R₃+R₅)=1×(1+1+1)=3). If the desired reference voltage is 3 volts, then the trim fuse circuit 700 enters the trim phase to trim the fuses as required.

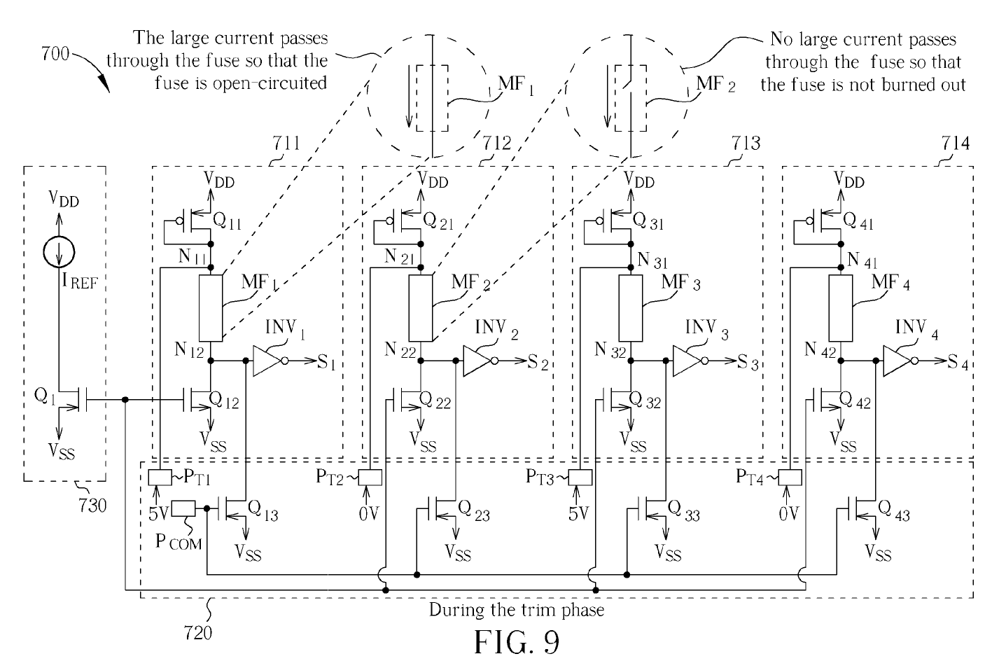

Please refer to FIG. 9. FIG. 9 is a diagram illustrating a trim fuse circuit 700 during the trim phase of the first embodiment of the present invention. According to FIG. 8, it is known that the switch control signals S₁˜S₄ are [0101] eventually. That is, the fuses MF₂ and MF₄ are required to be burned out so that the voltages on the nodes N₂₂, and N₄₂ respectively are kept at the low voltage level because of the nodes N₂₂ and N₄₂ are only respectively electrically connected to the voltage source V_{SS} through the transistors Q₂₂ and Q₄₂. In this way, the inverters INV₂ and INV₄ generate the switch control signals S₂ and S₄ with the logic “1”. The fuses MF₁ and MF₃ are required not to be burned out so that the voltages on the nodes N₁₂ and N₃₂ are kept at the high voltage level because of the nodes N₁₂ and N₃₂ are only electrically connected to the voltage source V_{DD} through the transistor Q₁₁ and Q₃₁. In this way, the inverters INV₁ and INV₃ generate the switch control signals S₁ and S₃ with the logic “0”. As a result, for burning out the fuses MF₂ and MF₄ during the trim phase, the common trim conducting pad P_{T2} and P_{T4} receives the trim common voltage with 5 volts (for turning on the transistors Q₂₃ and Q₄₃ so as to generate voltage drops on the fuses MF₂ and MF₄ with 5 volts) in order to burn out the fuses MF₂ and MF₄ with the large enough currents passing through.

In the trim fuse circuit 700 of the first embodiment of the present invention, the trim conducting pads P_{T1}˜P_{T4} are still disposed on the scribe lines of the wafer. Thus, the available area in the chips increases, and there is no risk of the incorrect switch control signals caused by contacting with the substrate. The detail is described as below.

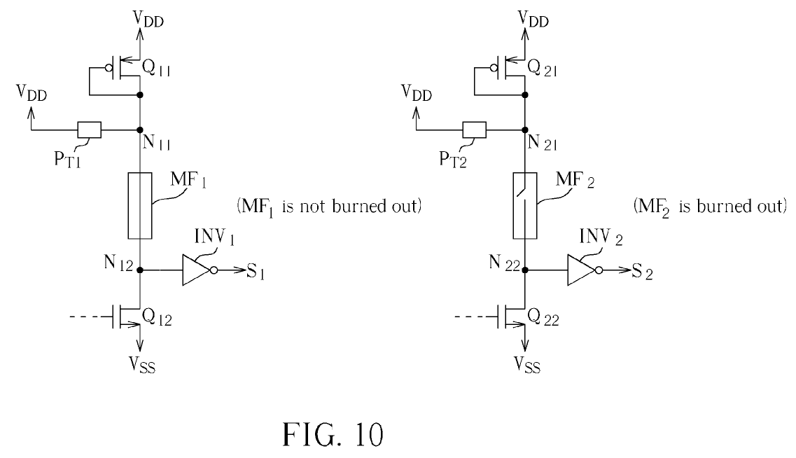

Please refer to FIG. 10. FIG. 10 is a diagram illustrating that, in the first embodiment of the present invention, even if the trim conducting pads of the trim fuse circuit 700 contacts with the substrate of the wafer, there is still no incorrect switch control signal generated. In FIG. 10, only the fuse sets 711 and 712 are illustrated as examples and the related description for the rest fuse sets will not be repeated again. As shown in FIG. 10, after the prediction phase in FIG. 8 and the trim phase in FIG. 9, the fuse MF₁ of the trim fuse set 711 is determined not to be trimmed. Since the transistor Q₁₂ is utilized for duplicating the current I_{REF} and the current I_{REF} is a very small current, the node N₁₂ is raised up to the high voltage level by the voltage source V_{DD} through the fuse MF₁ and the transistor Q₁₁. In this way, the switch control signal S₁ outputted from the inverter INV₁ is logic “0”. The fuse MF₂ of the trim fuse set 712 is determined to be burned out so that the node N₂₂ is pulled down to the low voltage level by the voltage source V_{SS} through the transistor Q₂₂. Hence, the switch control signal S₂ outputted from the inverter INV₂ is logic “1”. Although the trim conducting pads P_{T1} and P_{T2} are cut and is therefore stretched to electrically connect to the N-type substrate, the trim conducting pads P_{T1} and P_{T2} receive the voltage provided by the voltage source V_{DD} (for example, 5 volts) and transmit the voltage respectively to the nodes N₁₁ and N₂₁. However, in the fuse set 711 after the trim phase, the voltage on the node N₁₁ is kept at the high voltage level due to the voltage source V_{DD} through the fuse MF₁ and the transistor Q₁₁. In spite of the trim conducting pad P_{T1} transmitting the voltage provided by the voltage source V_{DD} from the N-type substrate, the voltage level of the node N₁₂ is still not affected so much and the inverter INV₁ does not generate the incorrect output. In the fuse set 712 after the trim phase, the voltage on the node N₂₂ is kept at the low voltage level due to the voltage source V_{SS} through the transistor Q₁₂. Meanwhile, the fuse MF₂ is trimmed to be open-circuited. In spite of the trim conducting pad P_{T2} transmitting the voltage provided by the voltage source V_{DD} from the N-type substrate, the voltage provided by the voltage source V_{DD} is still not transmitted to the node N₂₂ (because the fuse MF₂ is burned out). Thus, the voltage on the node N₂₂ is still not affected and the inverter INV₂ does not generate the incorrect output. Consequently, by utilizing the trim fuse circuit provided by the first embodiment of the present invention, the reference voltage obtained after the N-type wafer is scribed is the same as expected without being affected by the stretched trim conducting pads connecting to the N-type substrate.

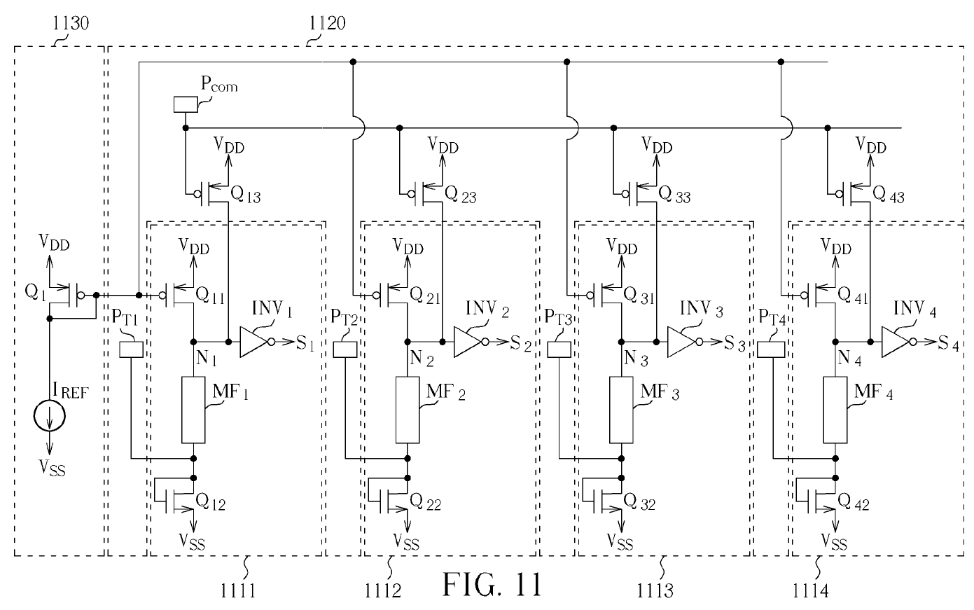

Please refer to FIG. 11. FIG. 11 is a diagram illustrating a trim fuse circuit 1100 of a second embodiment of the present invention. The trim fuse circuit 1100 is utilized for generating switch control signals S₁˜S₄. Different from the fuse circuit 700, the fuse circuit 1100 is utilized in the fabrication of the P-type substrate wafer. The trim fuse circuit 1100 is set for controlling the logic (voltage level) of the switch control signals S₁˜S₄. The trim fuse circuit 1100 comprises four fuse sets 1111, 1112, 1113 and 1114, a trim control module 1120 and a current control module 1130. The structure, function and operation principle of the trim fuse circuit 1100 are the same or similar with the trim fuse circuit 700 and will not be repeated again for brevity.

In summary, the trim fuse circuits of different embodiments of the present invention are utilized according to the type of the wafer fabrication. In this way, when the trim conducting pads are disposed on the scribe lines of the wafer, there is no risk of the incorrect action caused by the trim conducting pads cut and stretched by the scriber, which provides convenience.

Those skilled in the art will readily observe that numerous modifications and alterations of the device and method may be made while retaining the teachings of the invention.

What is claimed is:

1. A trim fuse circuit capable of disposing trim conducting pads on a scribe line of a wafer, the trim fuse circuit comprising:
a current control module, comprising:
a transistor, comprising:
a first end, electrically connected to a first voltage source;
a second end; and
a control end; and
a constant current source, electrically connected to the second end of the transistor of the current control module for generating a reference current;
a fuse set, comprising:
a first transistor, comprising:
a first end, electrically connected to a second voltage source;
a second end; and
a control end, electrically connected to the second end of the first transistor of the fuse set;
a second transistor, comprising:
a first end, electrically connected to the first voltage source;
a second end; and
a control end, electrically connected to the control end of the transistor of the current control module;
wherein the second transistor of the fuse set and the transistor of the current control module form a current mirror for generating the reference current from the second end of the second transistor of the fuse set;
a fuse, comprising:
a first end, electrically connected to the second end of the first transistor of the fuse set; and
a second end, electrically connected to the second end of the second transistor of the fuse set; and
an inverter, comprising:
an input end, electrically connected to the second end of the fuse; and
an output end for generating an information signal;
wherein when voltage level on the input end of the inverter is higher than a first predetermined voltage level, the information signal is at a low voltage level, and when the voltage level on the input end of the inverter is lower than a second predetermined voltage level, the information signal is at a high voltage level; and
a trim control module, comprising:
a trim conducting pad, disposed on the scribe line of the wafer;
a common trim conducting pad; and
a switch, comprising:
a first end, electrically connected to the input end of the inverter of the fuse set;
a second end, electrically connected to the first voltage source; and
a control end, electrically connected to the common trim conducting pad;
wherein the first end of the switch is electrically connected to the second end of the switch according to voltage on the common trim conducting pad.

2. The trim fuse circuit of claim 1, wherein the first predetermined voltage level and the second predetermined voltage level are between a third voltage level provided by the first voltage source and a fourth voltage level provided by the second voltage source.

3. The trim fuse circuit of claim 2, wherein the first predetermined voltage level is lower than the fourth voltage level and the second predetermined voltage level is higher the third voltage level.

4. The trim fuse circuit of claim 3, wherein when the trim fuse circuit is during a prediction phase, the trim conducting pad receives a prediction voltage for predicting the voltage level of the information signal outputted from the inverter.

5. The trim fuse circuit of claim 4, wherein voltage level of the prediction voltage is between the first predetermined voltage level and the fourth voltage level.

6. The trim fuse circuit of claim 4, wherein when the trim fuse circuit is during a trim phase, the common trim conducting pad receives a trim common voltage to turn on the switch for electrically connecting the first end of the switch to the second end of the switch, and the trim conducting pad receives a trim set voltage for trimming the fuse according to the predicted information signal of the trim fuse circuit during the prediction phase.

7. The trim fuse circuit of claim 1, wherein the switch is a transistor.

8. The trim fuse circuit of claim 7, wherein when the wafer is an N-type substrate wafer, the transistor of the current control module is an N channel Metal Oxide Semiconductor (NMOS) transistor, the first transistor of the fuse set is a P channel Metal Oxide Semiconductor (PMOS) transistor, the second transistor of the fuse set is an NMOS transistor, and the switch of the trim control module is an NMOS transistor.

9. The trim fuse circuit of claim 7, wherein when the wafer is a P-type substrate wafer, the transistor of the current control module is a PMOS transistor, the first transistor of the fuse set is an NMOS transistor, the second transistor of the fuse set is a PMOS transistor, and the switch of the trim control module is a PMOS transistor.

10. The trim fuse circuit of claim 1, wherein the information signal is utilized to control a reference voltage circuit for generating a reference voltage.

11. The trim fuse circuit of claim 1, wherein the fuse is a metal fuse.
